(19) United States
(12) Patent Application Publication
(10) Pub. No.: US 2008/0187830 A1
(43) Pub. Date: Aug. 7, 2008

(54) Tin-zinc secondary battery

(76) Inventor: John E. Stauffer, Greenwich, CT (US)

Correspondence Address: YOUNG & BASILE, P.C., 3001 WEST BIG BEAVER ROAD, SUITE 624, TROY, MI, 48084, US

(21) Appl. No.: 11/546,793

(22) Filed: Oct. 12, 2006

(51) Int. Cl. H01M 6/04; H01M 4/58; H01M 4/42

(52) U.S. Cl. 429/188; 429/229

(57) ABSTRACT

A rechargeable battery is provided with a positive electrode of tin, a negative electrode of zinc and an alkaline electrolyte. Upon charging, some tin is converted to stannic oxide, and zinc oxide is reduced to zinc. When the battery is discharged, stannic oxide is reduced to stannous oxide and zinc is oxidized to zinc oxide.

### FIELD OF THE INVENTION

The present invention relates to a novel type of storage battery. The positive electrode is made of tin which, during charging, is converted to stannic oxide, and the negative electrode is made of zinc. The electrolyte consists of an alkaline aqueous solution of an alkali metal hydroxide or tetramethyl ammonium hydroxide to which various buffers, including carbonates, borates, silicates and phosphates are added. Upon discharge the stannic oxide is reduced to stannous oxide and the zinc is oxidized to zinc oxide.

### BACKGROUND OF THE INVENTION

In a pending patent application, Ser. No. 11/249,223, the parent of which is Ser. No. 1110/756,015 filed Jan. 13, 2004, a secondary battery was disclosed which comprised a positive electrode of lead, a negative electrode of zinc and an alkaline electrolyte. This battery shows considerable promise, including low cost and high energy density. It is handicapped, however, by weight, due to the lead electrode, which restricts applications where mobility is needed. Secondly, the toxicity of lead is a drawback.

### SUMMARY OF THE DISCLOSURE

It is an object of the present invention to provide an improved storage battery that has maximum versatility and does not use a lead electrode.

A storage battery is fabricated from a positive electrode at tin and a negative electrode of zinc. During charging some tin is converted to stannic oxide. Upon discharge, stannic oxide is reduced to stannous oxide and zinc is oxidized to zinc oxide. These reactions are reversible such that the battery fulfills both functions of a secondary battery: supplying electricity on demand and storing or accumulating surplus electricity.

The electrolyte of the cell is alkaline. Aqueous solutions of bases provide the alkalinity. These bases include ammonia and the hydroxides of the alkali metals, namely, lithium, sodium, potassium and cesium. In addition, tetramethyl ammonium hydroxide may be employed.

Certain additives may be effective buffers in the electrolyte. These additives include carbonates, borates, silicates and phosphates.

### BRIEF DESCRIPTION OF THE DRAWING

The single figure shows a battery constructed in accordance with the invention.

### DETAILED DESCRIPTION

The theoretical potential of the battery of the present invention can be determined from the single electrode potentials. These potentials are given in the following equations that represent the reactions at each electrode.

Positive electrode:

Sn0₂+H₂O+2e⁻→SnO+2 OH⁻ 0.96 v 1.

Negative electrode:

Zn+2OH⁻→ZnO+H₂O+2e⁻ 1.216 v 2.

When these equations are combined, the overall reaction for the cell is obtained as follows:

SnO2+Zn→SnO+ZnO 2.176 v 3.

As the battery is discharged, there is no change in the average composition of the electrolyte although some concentration gradients will exist. During recharging of the cell, the reactions are reversed.

Negative electrodes of zinc have been employed in several types of secondary batteries. Tin, however, has never been reported as a positive electrode for such applications. One concern is the solubility of both stannous oxide and stannic oxide in concentrated alkali solutions.

Buffers are used to control the alkalinity of the electrolyte. These buffers may be selected from the group consisting of carbonates, borates, silicates and phosphates. They may be introduced by the corresponding acids or their respective salts.

Alkalinity is provided by compounds of the alkali metals, including lithium, sodium, potassium and cesium. Lithium has certain limitations because its carbonate and phosphate are practically insoluble in water. While ammonium hydroxide is basic in solution, its volatility restricts its use. Finally, tetramethyl ammonium hydroxide is known to be strongly alkaline.

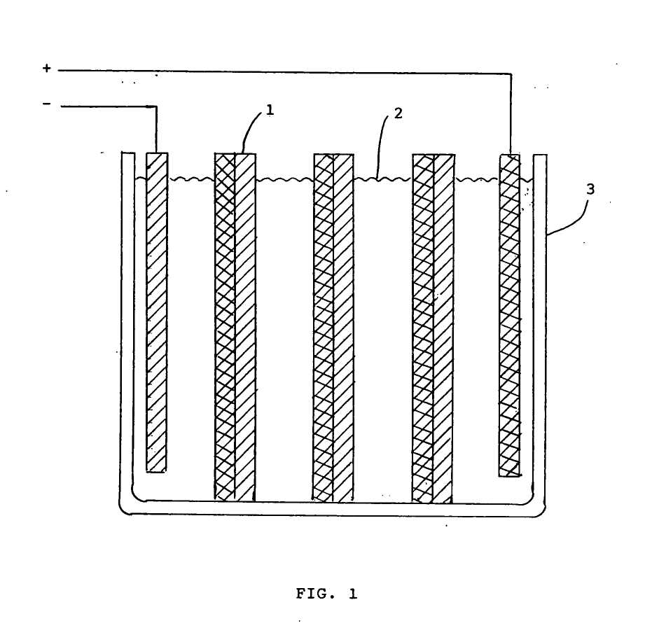

The configuration of a tin-zinc cell is not restricted. A preferred design, however, is a bipolar battery wherein several cells are integrated into a single package. FIG. 1 illustrates such a design. Bipolar electrodes 1 are comprised of tin (crosshatch) and zinc (striped). These electrodes are immersed in the alkaline electrolyte 2, which is contained in the individual compartments formed by the electrodes and casing 3. Electrical leads connect to the end electrodes. Spacers (not shown) may be inserted between the electrodes in order to minimize the danger of short-circuits.

The bipolar cell has the advantage of maximizing electrode surfaces while minimizing the electrical resistance. Its increased output voltage may also be a plus. Applications for the battery of the present invention are almost limitless.

What is claimed is:

1. A storage battery comprising:
(a) a positive electrode of tin,
(b) a negative electrode of zinc, and
(c) an alkaline electrode.

2. A storage battery of claim 1 in which the alkaline electrolyte is an aqueous solution of a hydroxide of an alkali metal.

3. A storage battery of claim 1 in which the alkaline electrolyte is an aqueous solution o tetramethyl ammonium hydroxide.

4. A storage battery of claim 1 in which the alkaline electrolyte contains a buffering agent selected from the group: carbonates, borates, silicates and phosphates.
